(19) United States
(12) Patent Application Publication
(10) Pub. No.: US 2006/0223453 A1
(43) Pub. Date: Oct. 5, 2006

(54) Frequency shifted wireless local area network system

(76) Inventors: G. Scott Griffin, Annapolis, MD (US); Sanjoy Sanyal, Burtonsville, MD (US)

Correspondence Address: BERENATO, WHITE & STAVISH, LLC, 6550 ROCK SPRING DRIVE, SUITE 240, BETHESDA, MD, 20817, US

(21) Appl. No.: 11/384,546

(22) Filed: Mar. 21, 2006

Related U.S. Application Data
(60) Provisional application No. 60/663,227, filed on Mar. 21, 2005.

(51) Int. Cl. H04B 1/38

(52) U.S. Cl. 455/73; 455/90.3

(57) ABSTRACT

A structure of circuit boards for a wireless communication apparatus, comprising a first radio-frequency circuit board provided with circuit devices for transmitting and receiving radio-frequency signals at a first frequency band mounted on the first radio-frequency circuit board; and a baseband circuit board provided with a baseband processor and a media access control for supporting the operation of radio-frequency circuit board, wherein the baseband circuit board is adapted to support different radio-frequency modules when the first radio-frequency circuit board is replaced with a second radio-frequency circuit board provided with circuit devices for transmitting and receiving radio-frequency signal at a second frequency band that is different than the first frequency band. In an alternate embodiment, the radio-frequency circuit board is not replaced but, instead, the RF circuit board and baseband circuit board are reprogrammed. The design of the baseband circuit board is irrelevant to the type of the circuit devices mounted on said radio-frequency circuit board so as to prevent the baseband circuit board from being affected by replacement of the radio-frequency circuit board.

This application claims the benefit under 35 U.S.C. § 119(e) of U.S. provisional patent application No. 60/663,227 filed Mar. 21, 2005, the entire disclosure of which is hereby incorporated by reference in this application.

### 1. FILED OF THE INVENTION

The invention relates to wireless LAN systems with versatile frequency band applications, and more particularly, to flexible wireless LAN systems that accommodate a wide variety of frequency band ranges.

### 2. DESCRIPTION OF RELATED ART

The networking of computer stations and other devices within a local area which may need to share information or resources is very well known in the prior art. Early advancements in device networking were accomplished through the use of cabling. Many different types of networks have been developed over the years in response for the need to share information or resources associated with a specific station (workstation) or control or sensing device.

Examples of communication networks include wired packet data networks, wireless packet data networks, wired telephone networks, wireless telephone networks, and satellite communication networks, among other networks. These communication networks typically include a network infrastructure that services a plurality of client devices. The Public Switched Telephone Network (PSTN) is a communication network that has been in existence for many years. The Internet is another well-known example of a communication network that has also been in existence for a number of years. These communication networks enable client devices to communicate with each other on a global basis. Wired Local Area Networks (LANs), e.g., Ethernets, are also quite common and support communications between networked computers and other devices within a serviced area. LANs also often link serviced devices to Wide Area Networks and the Internet. Each of these networks is generally considered a “wired” network, even though some of these networks, e.g., the PSTN, may include some transmission paths that are serviced by wireless links.

Wireless networks work on a principle that each node that may wish to communicate with another node or a server has some type of transceiver device for permitting the transmission and reception of wireless signals such that an over-the-air interface is established. The most common form of wireless signals used are RF signals or radio frequencies although other types of signals such as IR or infrared pulses can be used.

Many standards were developed in the early stages of wireless RF LAN development. To provide a level of consistency to the emerging technology, the Institute of Electrical and Electronics Engineers (IEEE) began accepting a standard in 1997 for wireless LAN technology known as 802.11. This standard has developed into a series or family of standards all falling under the umbrella of 802.11 (i.e., 802.11a, 802.11b, 802.1g) which address different transmission rates, different frequency bands as well as different encoding schemes (i.e., Direct Sequence Spread Spectrum or DSSS, Frequency Hopping Spread Spectrum or FSSS and even Orthogonal Frequency Division Multiplexing).

Wireless networks have been in existence for a relatively shorter period. Cellular telephone networks, wireless LANs (WLANs), and satellite communication networks, among others, are examples of wireless networks. Relatively common forms of WLANs are IEEE 802.11(a) networks, IEEE 802.11(b) networks, and IEEE 802.11(g) networks, referred to jointly as “IEEE 802.11 networks.” In a typical IEEE 802.11 network, a wired backbone couples to a plurality of Wireless Access Points (WAPs), each of which supports wireless communications with computers and other wireless terminals that include compatible wireless interfaces within a serviced area. The wired backbone couples the WAPs of the IEEE 802.11 network to other networks, both wired and wireless, and allows serviced wireless terminals to communicate with devices external to the IEEE 802.11 network.

WLANs provide significant advantages when servicing portable devices such as portable computers, portable data terminals, and other devices that are not typically stationary and able to access a wired LAN connection. However, WLANs provide relatively low data rate service as compared to wired LANs, e.g., IEEE 802.3 networks. Currently deployed wired networks provide up to one Gigabit/second bandwidth and relatively soon, wired networks will provide up to 10 Gigabit/second bandwidths. However, because of their advantages in servicing portable devices, WLANs are often deployed so that they support wireless communications in a service area that overlays with the service area of a wired network. In such installations, devices that are primarily stationary, e.g., desktop computers, couple to the wired LAN while devices that are primarily mobile, e.g., laptop computers, couple to the WLAN. The laptop computer, however, may also have a wired LAN connection that it uses when docked to obtain relatively higher bandwidth service.

With the continual advancement of technology, WLAN devices will include transceivers that may connect to other transceivers in a band extending from 2.4 to 2.5 GHz or in a band extending from 5.65 to 5.925 GHz. Transmissions in the 2.4 to 2.5 GHz band may conform to the IEEE 802.11(b)-1999 standard or to the developing standard in IEEE 802.11(g) Task Group G standards. Transmissions in the 5.65 to 5.925 GHz band may conform to the IEEE 802.11(a)-1999 standard. These operating standards define the operation within respective bands, e.g. channelization, signal format, etc. Thus, operation within each of these bands may be serviced according to one of a plurality of available operating standards.

Managing operation for wireless terminals within the plurality of available bands according to the plurality of protocol standards is difficult. Determining within which band to operate and determining which protocol standard to select is not defined in any of the above-referenced operating standards. Moreover, determining which channel to select in the band under these conditions is not defined in the above referenced operating standards. Thus, there is a need for a method of operation in a WLAN for supporting a plurality of available bands and a plurality of protocol standards.

One of the most inherent problems in wireless LANs relates to the limited band widths available for the wireless LAN.

Gateways and routers in addition to access points are common wireless communication apparatuses in a WLAN. Most of the circuit boards of the wireless communication apparatuses use SMT (Surface Mounting Technology) to adhere circuit devices such as base band, media access control (MAC) and radio-frequency (RF) devices onto the circuit boards. Accordingly, RF devices transfer high frequency signals, and thus the circuit design and the compatibility of related peripheral components are extremely important. Therefore, how to ensure that the RF device can exactly and stably operate is critical for wireless communication.

In order to achieve superior communication quality and stability, the new wireless communication protocol U-NII of 802.11a (47CFR15.401) additionally provides a band around 5 GHz for use. Furthermore, 802.11b/g ISM (47CFR15.247) designates that the band of 2.400-2.4835 GHz is used for radiation power below 1000 mW.

Accordingly, the frequency bands in different ranges employ different RF devices. Most RF components have narrow operational frequency range. When different RF devices are equipped to a circuit board, it is hard to guarantee that the RF devices and the related electronic devices, e.g., amplifiers and filters, on a circuit board will operate to the optimal level over a broad frequency range. If the set of an RF device and the related electronic devices cannot achieve expected performance, the whole circuit board may have to be discarded, which significantly increases the manufacturing cost. Therefore, the need exists for a flexible wireless LAN system that can accommodate different band ranges without changing the baseband section and the associated circuits, just by changing the RF section.

### SUMMARY OF THE INVENTION

The present invention provides a structure of circuit boards for a wireless communication apparatus as an alternative to the traditional circuit board to improve frequency band capabilities while reducing overall production costs.

The structure of circuit boards of the present invention includes a first RF circuit board and a second baseband circuit board. The RF module is used for signal transmitting and receiving, and includes a first circuit board and at least one RF device equipped on the first circuit board. The second circuit board comprises devices such as the baseband processor and media access control (MAC). At least one suitable connector is provided to permit replacement of the first RF circuit board on the surface of the second baseband circuit board.

In the first embodiment, the first RF circuit board is removably disposed on the surface of the second baseband circuit board. The second baseband circuit board is used to support different radio-frequency modules and the second circuit board is programmable and adaptable to the type of the radio-frequency device so as to prevent the second circuit board from being affected by replacement of the radio-frequency device. In the preferred embodiment, the media access control is reprogrammed to communicate with the selected RF circuit board.

In an alternate embodiment, the RF circuit board is not replaced but, instead, the first RF circuit board and second baseband circuit board are simply reprogrammed to be tailored to the specific RF spectrum.

### BRIEF DESCRIPTION OF THE DRAWINGS

FIG. 1 is a side view at the antenna interface of an exemplary wireless local area network incorporating features of the present invention.

FIG. 2 is an opposite side of the wireless LAN shown in FIG. 1 showing the interface connector.

FIG. 3 is a top view of the wireless LAN of FIG. 1 with the top plate removed.

FIG. 4 is a top view of the wireless of FIG. 1 with the top plate removed and the RF circuit board also removed.

FIG. 5 is a schematic representation of the circuitry of the best mode of the present invention.

### DETAILED DESCRIPTION OF THE PREFERRED EMBODIMENTS

The invention is a frequency-shifted Wireless Local Area Product (WLAN) access point (AP) for use in sensitive applications that can not use the standard frequency bands because of potential interference. Currently available WLAN products operate in one of two standard frequency bands: 2.40-2.485 Ghz or 5.650-5.925 Ghz. The invention will support any frequency from 1 GHz to 3 GHz with the selection of appropriate RF filters and firmware. Current wireless LANs are built on a single printed circuit board (and even a single IC solution) and are not designed to tune any non-standard frequency outside those two frequency bands.

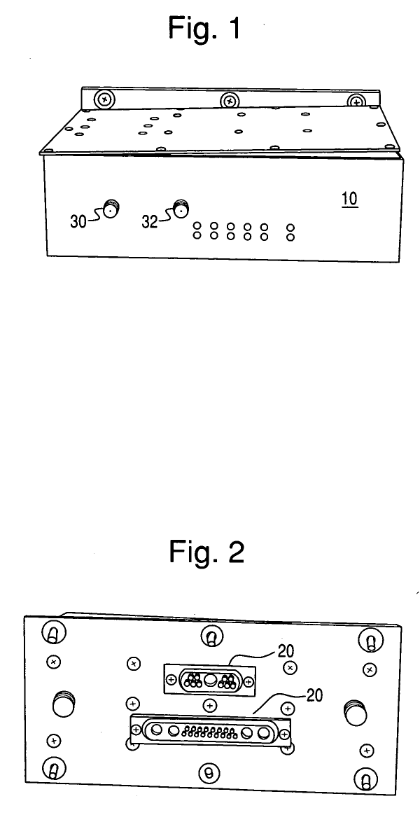

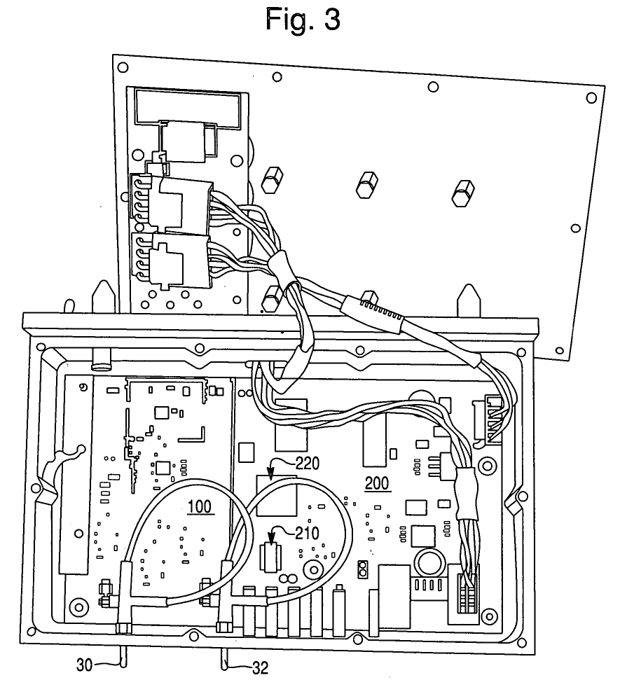

The device 1 shown in FIGS. 1-4 includes a housing 10 which carries an interface connector 20 at one end, and a pair of antennas 30, 32 at the opposite end. The interface connector 20 may be a PCMCIA connector or other similar connector that can readily interface to a number of possible LAN devices as will be appreciated by those skilled in the art.

The present invention includes a first RF circuit board 100 and a second baseband circuit board 200. The RF circuit board 100 is used for signal transmitting and receiving via antennae 30, 32, and includes a first circuit board 100 and RF circuitry disposed on the first circuit board 100.

The second circuit board 200 comprises devices such as the baseband processor 210 and media access control (MAC) 220.

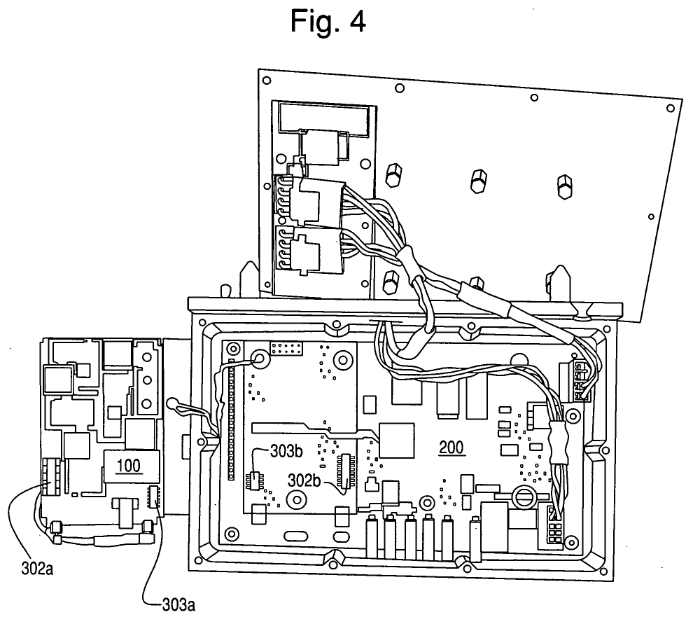

At least one suitable connector 300 is provided to permit replacement of the first RF circuit board 100 on the surface of the second baseband circuit board 200. The connector 300 preferable includes at least two pin-type connectors 302a, 302b, 303a, 303b shown in FIG. 4 where connector 302a is an electromechanical pin-type connector that mates with connector 302b and connector 303a is an electromechanical pin-type connector that mates with connector 303b.

In the first embodiment, the first RF circuit board 100 is removably disposed on the surface of the second baseband circuit board 200. The second baseband circuit board 200 is used to support different radio-frequency modules and the second circuit board is programmable and adaptable to the type of the radio-frequency device so as to prevent the second circuit board from being affected by replacement of the radio-frequency device. In the preferred embodiment, the media access control (MAC) 220 is reprogrammed to communicate with the selected RF circuit board 100.

In an alternate embodiment, the RF circuit board 100 is not replaced but, instead, the first RF circuit board 100 and second baseband circuit board 200 are simply reprogrammed to be tailored to the specific RF spectrum.

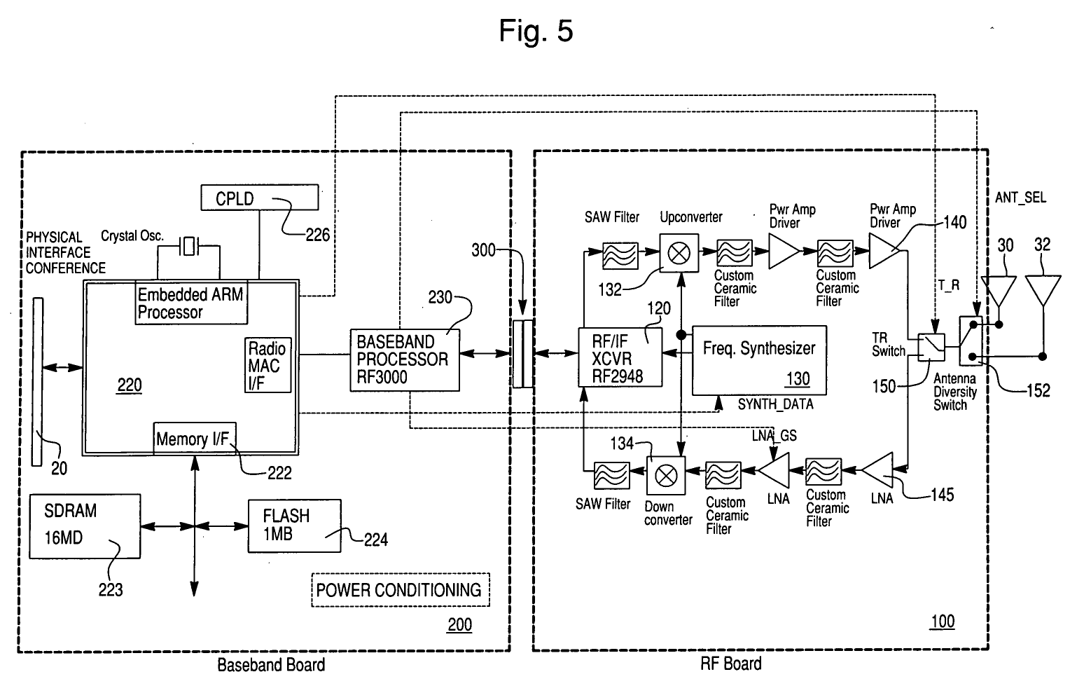

FIG. 5 is a diagram illustrating a WLAN circuitry according to the present invention. The invention comprises two independent circuit boards that are interconnected at the connector 300; the first RF circuit board 100 and the second baseband circuit board 200. The baseband circuit board 200 includes a media access control (MAC) 220 and a baseband processor 230. The MAC protocol is a protocol used on multiple access links to ensure that only one device has access to the shared link at any one time. The MAC protocol, in effect, allocates talking time to each device on the network. For example, the MAC protocol typically divides a single data frame into several time slots. Each device in the network transmits information in a particular time slot and listens in all other time slots of the frame. As each device has a fixed amount of bandwidth, that is, a fixed number of data bits which can be transmitter per second, under the MAC protocol, a fixed amount of data can be transmitted in the device's time slot.

An SDRAM interface 222 couples the MAC 220 to SDRAM 223 and to flash memory 224. A serial-to-parallel converter (CPLD) 226 is connected to the MAC 220.

The wireless transceiver includes a baseband processor 230 (e.g., model number RF3000), which provides the functions needed for a full or half-duplex packet baseband transceiver. The baseband processor 230 is connected, through the connector 300, to a radio frequency transmitter and receiver provided in the illustrated embodiment by the RF/IF converter 120, the power amplifier 140 connected to the transmit output, and the pair of switches 150, 152 connected to the antennas 30, 32

The RF transmitter and receiver is provided with a frequency synthesizer 130, an up converter 132, a power amplifier 42, an antenna switch 150, 152, a low noise amplifier 145, and a down converter 134. As known in the art, the frequency synthesizer 130 is for oscillating at a frequency in response to a control signal and outputs signals whose frequency hops successively. The up converter 132 is for receiving the frequency-hopping signals supplied from the frequency synthesizer 130.

The power amplifier 140 is for receiving the frequency transmission signals and for amplifying the transmission signals. The antenna switch 150, 152 is for receiving the amplified transmission signals and for controlling the antenna 30, 32 to wirelessly transmit the transmission signals to remote devices.

The antenna switch 150, 152 is also for controlling the antenna 30, 32 to receive signals at a particular frequency. The low noise amplifier 145 is for receiving via the antenna switch 150, 152 the received signals and for amplifying the received signals. The down converter 134 is for receiving: the amplified signals supplied from the low noise amplifier 145; and the frequency-hopping signals supplied from the frequency synthesizer 130. The down converter 134 is for mixing the signals with the frequency-hopping signals to generate output signals at a frequency. More specifically, the down converter 134 multiplies the received signals with the frequency-hopping signals, thereby recovering an original frequency output signal.

Unique features of the present invention include:

1. Frequency-shifted WLAN conforming to IEEE 802.11b protocols;

2. A modular two-board set for simplified modifications to RF frequency band;

3. Discrete RF design for simplified modifications to RF frequency band;

4. Higher RF power capability than standard WLANs;

5. Discrete RF filtering to improve potential interference;

6. Supports antenna diversity on two independent antennas;

7. Optionally configured for a dedicated transmit and receive antenna port.

One of the innovative design approaches provided by this invention for this WLAN AP product is such that it is two-circuit board modular design (as shown in FIGS. 1-5) with a digital/baseband board 200 and an RF board 100. In the preferred embodiment, the digital/baseband board 200 is built using standard ICs from Atmel Semiconductor. The RF board 100 is also designed with COTS ICs and some discrete circuit components. This approach provides great flexibility by allowing the WLAN AP to operate in a non-standard frequency band by changing the RF boards 100 while keeping the baseband section 200 and the IEEE 802.11b protocols the same. This product supports all the standard MAC Layer functions (Media Access Controller) as defined IEEE 802.11b.

Use of discrete components on the RF board 100 allows customization of the board to fit customer's specific requirements. For example, the RF bandpass filters can be tailored to provide a narrower RF spectrum for interference mitigation. This concept is preferably implemented on a different form-factor as a PCMCIA card as well.

Future enhancement to this concept would include a software-defined radio (SDR). Such an implementation would be done using software selectable band bass filters. This design would enable WLAN to tune to a wide frequency band using software rather than having to physically change the RF boards. Thus there would be a software defined frequency shifted Wireless LAN to enhance the flexibility of the proposed design.

While the foregoing invention has been shown and described with respect to a preferred embodiment and design, it will be understood that various changes in form and detail may be made therein without departing from the spirit and scope of the appended claims.

1. A structure of circuit boards for a wireless communication apparatus, comprising:
a first radio-frequency circuit board provided with circuit devices for transmitting and receiving radio-frequency signals at a first frequency band mounted on the first radio-frequency circuit board; and
a baseband circuit board provided with a baseband processor and a media access control for supporting the operation of said circuit devices mounted on said radio-frequency circuit board,
wherein said baseband circuit board is adapted to support different radio-frequency ranges when said first radio-frequency circuit board is replaced with a second radio-frequency circuit board provided with different circuit devices for transmitting and receiving radio-frequency signal at a second frequency band that is different than said first frequency band.

2. The structure according to claim 1, wherein at least one of the baseband processor and the media access control is adapted to be reprogrammed to communicate with said second radio-frequency circuit board.

3. The structure according to claim 1, further comprising a connector adapted to electrically connect the baseband circuit board with the first and second radio-frequency circuit boards in a modular manner.

4. The structure according to claim 1, wherein the first and second radio-frequency circuit boards transmits and receive said radio-frequency signals via antennae.

5. The structure according to claim 1, wherein the first and second radio-frequency circuit boards are removably disposed on a surface of said baseband circuit board.

6. The structure according to claim 1, wherein the media access control provides functions needed for at least one of a full-duplex and a half-duplex packet baseband transceiver.

7. The structure according to claim 1, wherein the baseband circuit board is connected to said radio-frequency circuit board by an RF/IF converter, a power amplifier and switches connected to antennae.

8. The structure according to claim 1, wherein the circuit devices for transmitting and receiving radio-frequency signals includes a frequency synthesizer, an up converter, a power amplifier, a low noise amplifier and a down converter.

9. The structure according to claim 1, wherein the design of the baseband circuit board is irrelevant to the type of the circuit devices mounted on said radio-frequency circuit board so as to prevent the baseband circuit board from being affected by replacement of the radio-frequency circuit board.

10. The structure according to claim 1, whereby the radio-frequency circuit board is tested alone before being installed on the second circuit board, and unqualified radio-frequency circuit boards can be filtered out and will not affect an assembly process.

11. The structure according to claim 1, wherein the radio-frequency circuit board and the baseband circuit board are connected by soldering.

12. The structure according to claim 1, wherein the baseband circuit board includes at least one socket for receiving the radio-frequency circuit board.

13. The structure according to claim 1, wherein the baseband circuit board includes at least one connecting finger for connection with the radio-frequency circuit board.

14. The structure according to claim 1, wherein said wireless communication apparatus is used in one of an access point, a gateway and a router.

15. The structure according to claim 1, wherein the radio-frequency circuit board is in compliance with one of the protocols of 802.11a, 802.11b, 802.11c, 802.11d, 802.11e, 802.11f, 802.11g, 802.11i and Bluetooth.

16. A structure of circuit boards for a wireless communication apparatus, comprising:
a radio-frequency circuit board provided with circuit devices for transmitting and receiving radio-frequency signals at a first frequency band mounted on the radio-frequency circuit board; and
a baseband circuit board provided with a baseband processor and a media access control for supporting the operation of said circuit devices mounted on said radio-frequency circuit board,
wherein said radio-frequency circuit board and said baseband circuit board are reprogrammable to support different radio-frequency ranges.

17. The structure according to claim 16, wherein at least one of the baseband processor and the media access control is adapted to be reprogrammed to communicate with said radio-frequency circuit board which is modified to operate at said different radio-frequency ranges.
